(19) United States
(12) Patent Application Publication
(10) Pub. No.: US 2004/0098259 A1
(43) Pub. Date: May 20, 2004

(54) Method for recognition verbal utterances by a non-mother tongue speaker in a speech processing system

(76) Inventor: Gerhard Niedermair, Vierkirchen (DE)

Correspondence Address: BELL, BOYD & LLOYD, LLC, P. O. BOX 1135, CHICAGO, IL, 60690-1135, US

(21) Appl. No.: 10/221,903

(22) PCT Filed: Dec. 22, 2000
(86) PCT No.: PCT/EP00/13391

(51) Int. Cl. G10L 15/00

(52) U.S. Cl. 704/254

(57) ABSTRACT

A speech recognition device, and method, are provided for recognizing and processing verbal utterances of a user in a first language, which includes a first phoneme-based speech model for recognizing verbal utterances in a first language and a second phoneme-based speech model for recognizing verbal utterances in a second language, wherein a selection device automatically selects, based on a verbal utterance of the user, either the first speech model or the second speech model for speech recognition, with the selected speech model being the one which provides a better recognition result of spoken phonemes of the user, and further includes a transfer device for transferring, when the second speech model has been used for speech recognition, phoneme sequences, which are spoken with the characteristics of the second language and are recognized by the second speech model, to words in the first language on the basis of the first speech model in order to recognize words in the first language which are spoken with an accent of the second language.

### BACKGROUND OF THE INVENTION

The present invention relates to a speech recognition system for recognizing and processing verbal utterances of a non-native language user, and relates to a method, which is used in such a system, for recognizing and processing verbal utterances of such a non-native language user.

Speaker-independent speech recognition systems are speech recognition systems whose individual users have not explicitly trained with this system; i.e., whose individual users have not deposited personal speech samples for the speech recognition. Such systems are used with respect to telephone information, banks and booking systems, for example. The user normally contacts the desired application (e.g., his/her bank) via the telephone in order to inquire about account status or in order to transfer money, for example.

Such speaker-independent speech recognition systems mostly use phoneme-based (=sound-based) speech models on the basis of which the speech recognition is carried out. These acoustic models are based on training material; i.e., the speech samples with the sound characteristics and speech characteristics of several thousand representative speakers, for example.

Normally, the speech material collected as such covers more or less efficiently the pronunciation versions (i.e., the acoustic realization versions of the sounds), of the users of the speech recognition system, particularly when the users are speakers whose native language is the applied language.

The problem, however, arises that users, whose native language is not the applied language, are by far less well recognized due to the different formation and particulars of the sounds (accent).

As such, the prior art only contains a few or no speech samples of non-native speakers with respect to the training material. An increase of the portions of non-native speakers regarding the training material has the result that the variance of the generated speech model or the bandwidth with which a sound is recognized, is enlarged. This, in turn, leads to a greater number of error detections.

Furthermore, the speech samples of a number of representative speakers of different nations would have to be deposited in the language of application (e.g., German) for every user group (e.g., French, Italian, Spanish etc.), so that the outlay would be intense.

Therefore, an object of the present invention is to provide a speech recognition system, and method, wherein a better recognition of non-native speakers, in a speech recognition system, is enabled.

### SUMMARY OF THE INVENTION

Two or more speech models are inventively used for the speech recognition of the verbal utterances of a user. The user language is the first language (e.g., German).

If a user, whose native language is the first language, has a dialog with the speech recognition device, the first speech model, which is based on the training material in the first language (German, in the example), is used for the speech recognition.

If a user, whose pronunciation in the first language is characterized by an accent in the second language (e.g., French accent), has a dialog with the speech recognition device, the second speech model, which is based on the training material in the second language (French, in the cited example), is used for the speech recognition. The inventive transfer device for the speech recognition transfers the sounds, which were spoken with the characteristics (i.e., with the accent), of the second language, onto words in the first language on the basis of the first speech model containing the words of the first speech.

An advantage of the present invention is that a separate speech model does not have to be prepared or, respectively, trained for recognizing the speech of users speaking the first language with an accent in the second language. In this case, existing speech models in the user language, in the second and further languages can be used for the speech recognition.

In order to recognize speech according to the present invention, what are referred to as multilingual speech models can be used for the speech recognition of a number of related languages. The speech recognition in the first language occurs as described above.

Additional features and advantages of the present invention are described in, and will be apparent from, the following Detailed Description of the Invention and the Figures.

### BRIEF DESCRIPTION OF THE FIGURES

FIG. 1 shows the schematic structure of a speech recognition system having the inventive speech recognition device.

### DETAILED DESCRIPTION OF THE INVENTION

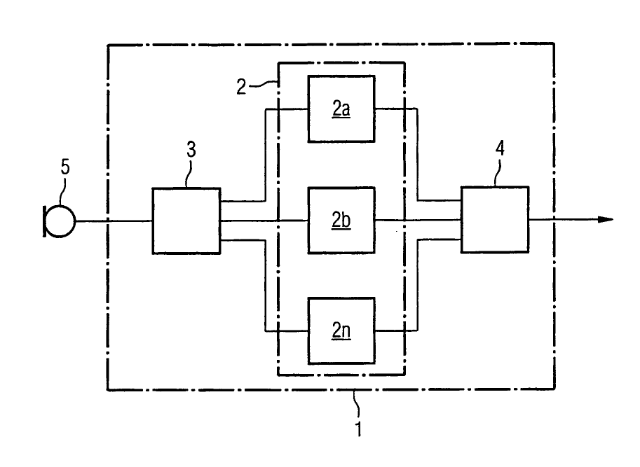

As can be seen from FIG. 1, the inventive speech recognition system is composed of the speech recognition device 1, a storing device with the individual speech models 2a, . . . 2n, each of which can be a part of a multilingual speech model 2, of the selection device for selecting the speech model and of the transmission device 4 for transferring sounds spoken with the characteristics of the second language onto words of the first language.

Furthermore, an input device 5 for inputting verbal utterances of the user is a part of the speech recognition system. The input device 5 is schematically shown as a microphone and can be the microphone of a telephone, for example, via which the user communicates with the speech recognition device.

An object of the present invention is to improve the speech recognition of non-native speakers in a specific language (German spoken by a French person, for example). This is achieved in that a multilingual speech model 2, which contains the training material for the German speech recognition and French speech recognition in the cited example, is used in order to recognize the non-native speakers in a specific language.

The speech recognition system uses the speech model 2a, which has been generated with native speakers of the user language, and uses the speech model 2b . . . 2n which have been generated with native speakers of one or more other languages (the multilingual models that are preferably composed of the languages whose users are to be recognized as foreign-language speakers of the user language).

The present invention is based on the fact that the individual speech models 2a . . . 2n contain the articulation peculiarities or, respectively, the characteristics of the sounds and that the users more or less strongly transfer these characteristics to the foreign language when the users speak a foreign language (e.g., the typical French accent). Since the multilingual speech models contain the articulation peculiarities of the foreign language, they are more suitable for recognizing a user of a language which is not his/her native tongue. Dependent on the degree of perfection of the user with respect to the user language, the corresponding speech model is used for the speech recognition.

At the beginning of the dialogue, for the speech recognition with one user, the selection device selects the speech model providing the best recognition results for the further recognition. For example, if the dialogue occurs with a user speaking the user language (e.g., German) with a strong foreign accent (e.g., French accent), the sounds (phonemes) are recognized by the corresponding speech model. On the basis of the first speech model, in which the training material for the first language or, respectively, user language, is stored, the inventive transmission device transfers the recognized sounds to words of the user language.

An advantage of the inventive method is that separate language-typical models need not be generated for non-native speakers (e.g., German spoken by French persons or Spanish persons) but, given the use, (possibly multilingual) speech models from the respectively foreign-language models and the corresponding language-typical model for native speakers can be simultaneously used.

Although the present invention has been described with reference to specific embodiments, those of skill in the art will recognize that changes may be made thereto without departing from the spirit and scope of the present invention as set forth in the hereafter appended claims.

1. Speech recognition device (1) for recognizing and processing verbal utterances of a user in a first language with a first phoneme-based speech model (2a) for recognizing verbal utterances in a first language and with a second phoneme-based speech model (2b0 for recognizing verbal utterances in a second language, characterized by a selection device (3) which, on the basis of a verbal utterance of the user, automatically selects the first speech model (2a) or the speech model (2b) for the speech recognition, whereby the speech model (2a, 2b) is selected which provides a better recognition result of spoken phonemes of this user, and a transfer device (4) wich, when the second speech model (2b) has been used for the speech recognition, transfers phoneme sequences, which are spoken with the characteristics of the second language and are recognized by the second speech model (2b), to words in the first language on the basis of the first speech model (2a) in order to recognize words in the first language which are spoken with an accent of the second language.

2. Speech recognition device (1) according to claim 1, characterized by more than two phoneme-based speech models (2a...2n) for recognizing verbal utterances in more than two languages, whereby said speech models recognize phoneme sequences spoken with the characteristics of the further languages.

3. Speech recognition device (1) according to claim 1 or 2, characterized in that the individual speech models (2a...2n) are part of a multilingual overall speech model (2).

4. Method for recognizing and processing verbal utterances of a user in a first lanuguage, characterized by the steps automatically selecting a first speech model (2a) or a second speech model (2b) for the speech recognition on the basis of a verbal utterance of the user, whereby the speech model (2a, 2b) is selected which provides a better recognition result of spoken phonemes of this user, and, when the second speech model (2b) has been selected for the speech recognition, transferring phoneme sequences which are spoken with the characteristics of the second language and are recognized by the second speech model (2b), on the basis of the first speech model (2a), to words in the first language in order to recognize words in the first language that are spoken with an accent of the second language.

5. Method according to claim 4, characterized in that more than two phoneme-based speech models (2a...2n) are used for recognizing verbal utterances in more than two languages, whereby phoneme sequences spoken with the characteristics of the further languages are recognized by said speech models.

6. Method according to claim 4 or 5, characterized in that the individual speech models (2a...2n) respectively are a part of a multilingual overall model (2).
